(19) United States
(12) Patent Application Publication
(10) Pub. No.: US 2026/0006656 A1
(43) Pub. Date: Jan. 1, 2026

(54) VEHICLE TO VEHICLE COMMUNICATION SYSTEMS

(71) Applicant: FCA US LLC, Auburn Hills, MI (US)

(72) Inventors: Evan J. Oswald, Auburn Hills, MI (US); Marcus Hemmye, Auburn Hills, MI (US); Keith M. Wasserman, Auburn Hills, MI (US); Payam Akbari, Auburn Hills, MI (US)

(21) Appl. No.: 18/758,094

(22) Filed: Jun. 28, 2024

(51) Int. Cl. H04W 76/14; H04W 4/46; H04W 76/18

(52) U.S. Cl. CPC H04W 76/14; H04W 4/46; H04W 76/18

(57) ABSTRACT

A method for providing communication between a first vehicle and a second or target vehicle, includes determining a presence of accessible vehicles in the vicinity of a first vehicle, selecting a target vehicle from the accessible vehicles, creating a communication in the first vehicle, reviewing the communication with a content filter to determine if the communication is acceptable, and sending an acceptable communication to the target vehicle.

### FIELD

The present disclosure relates to a vehicle to vehicle communication systems.

### BACKGROUND

When driving, a vehicle occupant may notice something wrong with another vehicle on the road and wish to communicate what has been noticed to the other vehicle. Unless the phone number of an occupant of the other vehicle is known, clear communication is not possible. Drivers then resort to flashing lights or high beams, or honking their horn to try and gain the attention of the driver of the other vehicle. Even if successful in gaining the driver's attention, communication can only occur via hand gestures or the like, assuming eye contact can be sufficiently maintained.

### SUMMARY

In at least some implementations, a method for providing communication between a first vehicle and a second or target vehicle, includes determining a presence of accessible vehicles in the vicinity of a first vehicle, selecting a target vehicle from the accessible vehicles, creating a communication in the first vehicle, reviewing the communication with a content filter to determine if the communication is acceptable, and sending an acceptable communication to the target vehicle.

In at least some implementations, the reviewing step is accomplished with software stored in the first vehicle. In at least some implementations, the reviewing step is accomplished with software stored in a cloud-based backend portion.

In at least some implementations, the step of determining the presence of accessible vehicles is accomplished by a cloud-based backend portion.

In at least some implementations, the message is created via speech.

In at least some implementations, the method also includes providing an alert in the target vehicle when the message is transmitted to the target vehicle.

In at least some implementations, the step of selecting a target vehicle includes selecting more than one target vehicle, and the step of sending the acceptable communication includes sending the acceptable communication to each of the more than one target vehicles.

In at least some implementations, the reviewing step includes analyzing the communication with a content filter to ensure the communication does not include profanity, hate speech, or content predetermined to invoke anger in a recipient.

In at least some implementations, the creating step is accomplished with an infotainment system of the first vehicle. In at least some implementations, the creating step is accomplished via voice inputs to the infotainment system.

In at least some implementations, a vehicle communication system, includes a control system that includes a data storage unit and an electronic control unit, a communications unit that is communicated with the control system and that has a receiver by which information is received at a first vehicle and a transmitter by which information is transmitted from the first vehicle, and a backend portion of a cloud-based system. The backend portion includes a processor and memory with programming to determine accessible vehicles in the vicinity of a first vehicle, and select a target vehicle from the accessible vehicles. The control system includes programming to create a communication in the first vehicle, and one or both of the control system and the backend portion include programming to send a communication to the target vehicle.

In at least some implementations, one or both of the control system and the backend portion include programming to review the communication with a content filter to determine if the communication is acceptable, and the sending step occurs only if the communication is determined to be acceptable.

In at least some implementations, the backend portion communicates with the accessible vehicles and determines the location of the accessible vehicles.

In at least some implementations, the backend portion includes information relating to identification of the accessible vehicles including one or more of the make, model, color, and license plate.

In at least some implementations, the system includes an infotainment system including a display and a user interface, and wherein the communication is created via the user interface. In at least some implementations, the user interface includes a microphone by which the message may be created with speech. In at least some implementations, one or both of the control system and the backend portion include programming to convert the speech to text, and to review the text with a content filter to determine if the communication is acceptable.

In at least some implementations, one or both of the control system and the backend portion include programming to provide an alert in the target vehicle when the communication has been sent to the target vehicle.

In at least some implementations, one or both of the control system and the backend portion include programming to inform a user when a communication is determined to not be acceptable.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a vehicle communication system for multiple vehicles;

FIG. 2 is a diagrammatic view of a vehicle that defines part of the system;

FIG. 3 is a diagrammatic view of the communication system; and

FIG. 4 is a flowchart of a method for managing notifications to a vehicle user.

### DETAILED DESCRIPTION

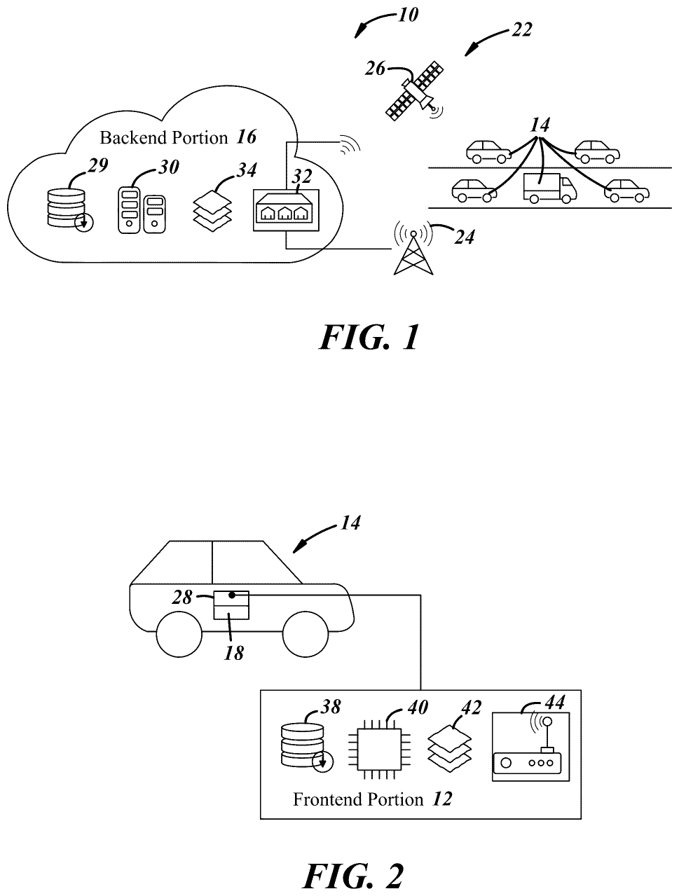

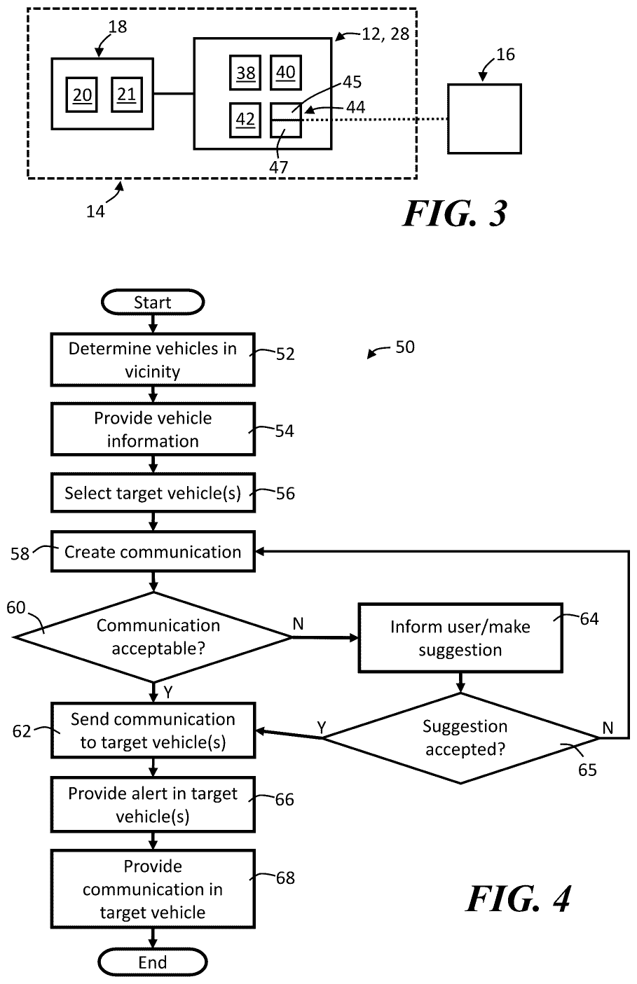

Referring in more detail to the drawings, FIG. 1 illustrates a vehicle communication system 10 including a frontend portion 12 with one or more network vehicles 14 that are in communication with a backend portion 16 via one or more communication devices and suitable communication protocols. The network vehicles include in-vehicle infotainment (IVI) systems 18 (FIGS. 2 and 3) that utilize a combination of software and hardware components to provide a wide range of information, system controls and entertainment. As diagrammatically shown in FIG. 3, the IVI system 18 may include one or more display screens 20 and a user interface 21. The user interface may include various inputs, like buttons, switches, touch-sensitive areas of the screen 20, microphone(s) for audio or voice commands and inputs, and the like.

With reference to FIGS. 1-3, the vehicle communication system 10 may be a cloud-based system that may receive incoming information from individual ones of the network vehicles 14 and send outgoing information to one or multiple network vehicles 14, where the outgoing information may include mass communications (i.e. notifications) that are the same for multiple vehicles or individual communications that are each specific to the vehicle to which each individual communication is sent. The system 10 may gather real-time information from network vehicles 14, may gather information at determined intervals or times, and the system 10 may analyze the information and determine if a notification should be sent to one or more vehicles as noted in more detail later

The term “real-time”, as used herein, does not strictly require that such information and notifications be generated, sent, received and/or otherwise processed at the exact moment when their underlying events or conditions occur in order to be “real-time”. Rather, these terms broadly include any such information and notifications that are generally contemporaneous with their underlying events or conditions so that the environmental conditions information and notifications are still relevant or accurate in the context of the present system and method (e.g., within seconds, minutes or even hours of their underlying events or conditions). Further, information may be sent from or a vehicle as during use of the vehicle, or before or after use of the vehicle.

System 10 may deliver hosted services via the internet and/or other communication networks and may be structured as a public, private or hybrid cloud, for example. According to one non-limiting example, vehicle communication system 10 is structured as a private cloud and generally includes the backend portion 16 and the frontend portion 12 that is distributed across a fleet of network vehicles 14, where each network vehicle 14 is capable of obtaining and providing information as well as communicating with the backend portion 16 over a secure communications network 22 (e.g., secure vehicle-to-cloud (V2C) network), and/or communicating with other vehicles via a vehicle-to-vehicle (V2V) connection. The secure communications network 22 may include a cellular-based network 24, a satellite-based network 26, a city-wide WiFi-based network, some other type of communications network and/or a combination thereof. Although only a few network vehicles 14 are shown in the drawings, it should be appreciated that system 10 may interact with a large fleet of vehicles that can include dozens, hundreds, thousands or even more vehicles. System 10 may be used with any vehicles, including (but not limited to) passenger, commercial and/or public transportation vehicles sold in any geographic area.

Backend portion 16 may include any suitable combination of software and/or hardware resources typically found in a backend of a cloud-based system, as best illustrated in FIG. 1. The backend portion 16 may be responsible for managing some of the programs and algorithms that run applications on the frontend portion 12, such as those that request, obtain and optionally analyze information of and from the network vehicles 14. It is noted that the data/information used to formulate notifications and information for vehicles may be analyzed by control systems 28 and processors on-board a network vehicle 14 or by the backend portion 16 or both, as desired. The backend portion 16 may be managed or controlled by the vehicle manufacturer and can be part of a larger cloud-based system that the vehicle manufacturer uses to communicate and interact with a large fleet of vehicles for a multitude of purposes. For example, the backend portion 16 may include or communicate with emergency alert systems, such as those that provide Amber alerts or other missing persons alerts, or law enforcement systems that may provide and receive information regarding vehicles of interest to them.

The backend portion 16 may include any suitable combination of software and/or hardware resources including, but not limited to, components, devices, computers, modules and/or systems such as those directed to applications, service, storage, management and/or security (each of these resources is referred to herein as a “backend resource,” which broadly includes any such resource located at the backend portion 16). In one example, the backend portion 16 has a number of backend resources including data storage systems 29, processors or servers 30, communication systems 32, programs and algorithms 34, as well as other suitable backend resources. It should be appreciated that backend portion 16 is not limited to any particular architecture, infrastructure or combination of elements, and that any suitable backend arrangement may be employed.

Frontend portion 12 may include any suitable combination of software and/or hardware resources typically found in a frontend of a cloud-based system, as shown in FIG. 2, and is generally responsible for sending information to the backend portion and receiving notifications, programs, instructions and the like from the backend portion 16. Depending on the particular arrangement, the frontend portion 12 may also be responsible for gathering camera, sensor, location and/or other data from devices on the vehicle 14, and sending such information to the backend portion 16. The frontend portion 12 is typically responsible for running the applications that interface with the users in the different vehicles 14, and for interfacing with the programs and algorithms 34 of the backend portion 16. The frontend portion 12 may also be managed or controlled by the vehicle manufacturer and can be part of a larger cloud-based system that the vehicle manufacturer uses to communicate and interact with a large fleet of vehicles for various purposes, as mentioned above. The frontend portion 12 may be distributed across one or more vehicles 14 and may include any suitable combination of software and/or hardware resources including, but not limited to, components, devices, computers, modules and/or systems (each of these resources is referred to herein as a “frontend resource,” which broadly includes any such resource located at the frontend portion 12).

In one example, the frontend portion 12 has a number of frontend resources including a vehicle control system 28 having one or more vehicle electronic module(s) installed in vehicles 14, which may include some combination of a data storage unit 38, an electronic control unit and/or processor(s) 40, applications 42, a communications unit 44 (e.g., one that includes a telematics unit and/or other communication devices with a receiver 45 by which information is received at unit 44 and a transmitter 47 by which information is sent from the unit 44), as well as other suitable frontend resources. The control system 28 may be or include a telematics box module (TBM), a telematics control module (TCM), a body control module (BCM), an electronic control unit (ECU), an infotainment control module, or any other suitable module known in the art. It is not necessary for the preceding units to be packaged in a single vehicle electronic module, as illustrated in FIG. 2; rather, they could be distributed among multiple vehicle electronic modules, they could be stand-alone units, they could be combined or integrated with other units or devices, or they could be provided according to some other configuration. It should be appreciated that frontend portion 12 is not limited to any particular architecture, infrastructure or combination of elements, and that any suitable frontend arrangement may be employed.

In order to perform the functions and desired processing set forth herein, as well as the computations therefore, the control system 28 may include, but is not limited to, one or more controller(s), control unit(s), processor(s), computer(s), DSP(s), memory, storage, register(s), timing, interrupt(s), communication interface(s), and input/output signal interfaces, and the like, as well as combinations comprising at least one of the foregoing, as generally described with regard to the frontend portion 12. For example, the control system 28 may include input signal processing and filtering to enable accurate sampling and conversion or acquisitions of such signals from communications interfaces and sensors. As used herein the terms control system 28 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The control system 28 may be distributed among different vehicle modules, such as an infotainment system control module, engine control module or unit, powertrain control module, transmission control module, and the like, if desired, and the memory and one or more processors may be one or both integrated into the vehicle 14 or remotely located and wirelessly communicated to the vehicle 14, as desired.

The term “memory” or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions executable by a processor or controller or the like to enable control or allocate resources of a computing device.

At times, one or more people in one vehicle may wish to communicate with one or more vehicles on the road in the area of their vehicle. The communication may be to alert others to certain situations, for example, an unsafe vehicle condition like a low tire pressure, loose cargo, debris on the vehicle, something being dragged by the vehicle, an open trailer door or other trailer conditions, or the like. Without direct contact information for the people in other vehicles, communication between vehicles is difficult, and people sometimes flash their lights or honk the vehicle horn to gain the attention of others, with communication thereafter by hand gestures and the like. Needless to say, it is difficult to effectively communicate in this way.

The vehicle communication system 10 can permit communication from one vehicle to one or more vehicles, at least for network vehicles, which are vehicles that are connected to the network and setup to receive communications from another vehicle or from the backend portion. The communication may occur through a suitable interface, which may be software/app based and resident on the vehicle (e.g. accessible through the IVI system 18), the backend portion and/or a remote device such as a smartphone, tablet or computer (e.g. a portable computer).

FIG. 4 illustrates an example method 50 for enabling communication from a first vehicle to a second vehicle. The method may begin at step 52 in which the first vehicle, via a suitable software interface, sends a request to determine vehicles in the vicinity of the first vehicle that are accessible from the network. This may be done, for example, by the vehicle/frontend portion wirelessly sending out a request or “ping” that is received at vehicles within a certain range of the first vehicle. Vehicles within range and accessible via the network may respond to the first vehicle or to the backend portion. While not intending to limit the innovations described herein, in at least one implementation, the other vehicles may have a communication unit in sleep mode and when a ping or request is received, the communication unit becomes active and a response is sent (the communication unit may be active for some purposes and in a sleep or inactive mode for other purposes, as desired). In step 54, information relating to the accessible vehicles in the vicinity of the first vehicle is provided to the first vehicle (e.g. by the backend or frontend portion or both), where, in at least some implementations, accessible vehicles are vehicles with which communication may be accomplished. In other implementations, the accessible vehicles may be all vehicles that can be located by the system whether those vehicles are equipped or setup to receive communications from another vehicle or not.

The information enables identification of vehicles and from that identification, in step 56, a user in the first vehicle can select a target vehicle for the communication. Examples of the information may include icons or graphic images representing the vehicle, or data like the color, make, model, and other information such as the license plate or the like. Thus, if there are two other vehicles near the first vehicle, for example a green car and a red SUV, the information will permit the user in the first vehicle to select the target vehicle one of the two vehicles that is the target vehicle. If the target vehicle is not accessible, information to that effect may be provided to the first vehicle or the target vehicle will simply not be listed or included in the information about the networked/accessible vehicles, and the method in that instance would then end.

When the target vehicle is selected, the method continues to step 58 in which the user in the first vehicle provides a communication that they would like to transmit to the second (i.e. target) vehicle. The communication may be in any suitable form, such as but not limited to text, speech to text, graphics (e.g. emojis or similar graphic representations) or recorded speech in the form of an audio file. The communication could include any information desired by the user or it could be constrained to pre-approved choices stored in memory of the first vehicle or the backend portion, and made available to the user. In at least some implementations, recorded speech is preferred to reduce distraction to a driver and to facilitate completing the communication.

In at least some implementations, the communication is reviewed, in step 60, to try and ensure that the message is relevant to one or more types of communications which may be predetermined. This may be done by software resident on one or both of the frontend portion and the backend portion. The software may include a list of words or phrases or concepts that have been deemed not appropriate for the V2V communication. Profanity and concept/content related filtering software is known and available, or custom filtering software or filters could be used, as desired. Beyond profanity or hate speech or indecent phrases or words, the system may be setup to detect the content, for example but not limited to, insulting communications or communications that might induce anger in the recipient. By way of a couple examples, communications such as “you have a loose strap on your trailer” or “there is something being dragged under your vehicle” would be acceptable, while “learn how to drive, idiot” or “pull over and I'll beat you up” would not be acceptable because they are insulting or inflammatory. The filtering algorithms or programs could be updated via machine learning/artificial intelligence algorithms that learn from the communications between many network vehicles over time, and, for example, user feedback may be requested and analyzed to improve the effectiveness of the filtering and communications in general. In some implementations, the filtering may be done to limit messages to safety or driving related communications, and to avoid random messages just seeking communication with other drivers. Of course, the communications need not be so limited and options may be provided to users to select from different categories of concepts or types of messages they wish to receive or not receive.

Communications that are determined after review to be acceptable may be transmitted to the target vehicle in step 62 by establishing a connection with a communication device of the target vehicle or associated therewith (e.g. a smartphone associated with the target vehicle). This may be done from the communication device 44 of the first vehicle to the second vehicle, via a wireless local network, with information needed to establish the connection provided from the frontend or backend portion, for example, when the target vehicle is selected. Or the communication may be sent from the first vehicle to the backend portion and then from the backend portion to the second or target vehicle.

Phrases that are deemed to be not acceptable will not be delivered to the second vehicle. Instead, the system may, in step 64, inform the user that the communication is not acceptable and/or suggest an alternate communication from a list or database of acceptable communications or ask the user to provide a new communication. If the system-provided alternate communication is accepted, the method may loop to step 62 and the message may be transmitted to the second vehicle. The system may also indicate why the user-generated communication was deemed to be not acceptable to assist the user in providing an acceptable communication. This may be done by providing to the user, from the frontend or backend portions, a response selected from a list or database of responses and based on a category including the reason that the communication was not accepted. For example, the categories may include categories relating to profanity, inflammatory content, indecent content and other categories, with one or more responses (e.g. your message was deemed to be inappropriate because it included profanity) relating to each category being available for selection. If the user does not accept the alternate communication, as noted in step 65 as proposed, the method may loop back to step 58 for the user to provide a new communication and then to step 60 for review of the new communication provided by the user.

A user in the second vehicle may similarly interact with the communication system 10, e.g. via the IVI system of the second vehicle or a remote device. The communication from the first vehicle may, in step 66, cause an alert or message to be provided to the user of the second vehicle, similar to alerts of messages that may appear for text messages sent to a user's phone or the like. The user of the second vehicle can choose when to review the message, which may be provided, in step 68, as text, text to speech, or by playing an audio file sent by the first user. After reviewing the communication, the user of the second vehicle may provide a return communication to the first vehicle, if desired, and the return communication may be provided in the same manner as the original communication, with the same reviews/filters and so on. Further, the user of the second vehicle can provide feedback to the system regarding the quality or appropriateness of the communication, so that the system can learn and continually be improved, as noted above.

While the example method 50 is set forth with regard to communication from one vehicle to one other vehicle, a communication may be provided to multiple other vehicles, e.g. multiple target vehicles. Non-limiting examples are to notify other vehicles of an unsafe road condition, like a flooded section of road, a road blockage due to a rock slide or avalanche or accident, or to notify other vehicles that the first vehicle/people therein either need assistance or do not need assistance. For example, if a vehicle is pulled onto the shoulder of a road with a flat tire, the communication could alert passersby that help is not needed so that the passersby do not stop to assist when not necessary. Such communications could be provided only to network vehicles that are in the vicinity, and perhaps only those traveling in a direction indicating that they will pass the area of interest. To ensure the communication is relevant when delivered, the communication could be limited to being sent only to vehicles in a certain geographic area for a determined, limited amount of time (which may be predetermined in the system and/or selectable by a user). In this way, the communication may be provided in a “broadcast” mode in which the message periodically is sent over time to all vehicles in an area or as a vehicle enters an area within the allotted time for the broadcast communication. Further, each vehicle could be given the option to opt-in or opt-out of any or all communications, with selections to, for example, opt-out of multiple vehicle communications only, single vehicle to single vehicle communications only, or all communications.

Among other things, the communication system 10 can facilitate providing clear communications to the other vehicles instead of ambiguous signals such as honking the horn or flashing lights/high beams. The network may include all vehicles having capability to receive messages and is not limited to only vehicles within a certain network (e.g. only vehicles from a single manufacturer). The communications can be generated in a hands-free, non-distracting way, such as by speech to text or via audio files. Users can opt-in or out to all or certain messages to limit annoyance or distractions. The system can be used to connect to vehicles travelling in different directions, making it possible to warn, for example, oncoming traffic as well as flowing traffic of perceived safety hazards.

What is claimed is:

1. A method for providing communication between a first vehicle and a second or target vehicle, comprising:
determining accessible vehicles in the vicinity of a first vehicle;
selecting a target vehicle from the accessible vehicles;
creating a communication in the first vehicle;
reviewing the communication with a content filter to determine if the communication is acceptable; and
sending an acceptable communication to the target vehicle.

2. The method of claim 1 wherein the reviewing step is accomplished with software stored in the first vehicle.

3. The method of claim 1 wherein the reviewing step is accomplished with software stored in a cloud-based backend portion.

4. The method of claim 1 wherein the step of determining accessible vehicles is accomplished by a cloud-based backend portion.

5. The method of claim 1 wherein the message is created via speech.

6. The method of claim 1 which also includes providing an alert in the target vehicle when the message is transmitted to the target vehicle.

7. The method of claim 1 wherein the step of selecting a target vehicle includes selecting more than one target vehicle, and the step of sending the acceptable communication includes sending the acceptable communication to each of the more than one target vehicles.

8. The method of claim 1 wherein the reviewing step includes analyzing the communication with a content filter to ensure the communication does not include profanity, hate speech, or content predetermined to invoke anger in a recipient.

9. The method of claim 1 wherein the creating step is accomplished with an infotainment system of the first vehicle.

10. The method of claim 9 wherein the creating step is accomplished via voice inputs to the infotainment system.

11. A vehicle communication system, comprising:
a control system that includes a data storage unit and an electronic control unit;
a communications unit that is communicated with the control system and that has a receiver by which information is received at a first vehicle and a transmitter by which information is transmitted from the first vehicle; and
a backend portion of a cloud-based system, wherein the backend portion includes a processor and memory with programming to determine accessible vehicles in the vicinity of a first vehicle, and select a target vehicle from the accessible vehicles, and wherein the control system includes programming to create a communication in the first vehicle, and wherein one or both of the control system and the backend portion include programming to send a communication to the target vehicle.

12. The system of claim 11 wherein one or both of the control system and the backend portion include programming to review the communication with a content filter to determine if the communication is acceptable, and the sending step occurs only if the communication is determined to be acceptable.

13. The system of claim 11 wherein the backend portion communicates with the accessible vehicles and determines the location of the accessible vehicles.

14. The system of claim 11 wherein the backend portion includes information relating to identification of the accessible vehicles including one or more of the make, model, color, and license plate.

15. The system of claim 11 which includes an infotainment system including a display and a user interface, and wherein the communication is created via the user interface.

16. The system of claim 15 wherein the user interface includes a microphone by which the message may be created with speech.

17. The system of claim 16 wherein one or both of the control system and the backend portion include programming to convert the speech to text, and to review the text with a content filter to determine if the communication is acceptable.

18. The system of claim 11 wherein one or both of the control system and the backend portion include programming to provide an alert in the target vehicle when the communication has been sent to the target vehicle.

19. The system of claim 11 wherein one or both of the control system and the backend portion include programming to inform a user when a communication is determined to not be acceptable.
